(19) United States
(12) Patent Application Publication
(10) Pub. No.: US 2007/0224414 A1
(43) Pub. Date: Sep. 27, 2007

(54) PROTECTIVE COATING FOR ROOF MEMBRANE

(76) Inventors: Timothy J. Leonard, Delano, MN (US); Tony L. Leonard, Maple Grove, MN (US); James D. Leonard, Chaska, MN (US); Laura L. Vollenweider, New Hope, MN (US)

Correspondence Address: MOORE & HANSEN, PLLP, 225 SOUTH SIXTH ST, MINNEAPOLIS, MN, 55402, US

(21) Appl. No.: 11/277,390

(22) Filed: Mar. 24, 2006

(51) Int. Cl. B32B 27/30; B32B 27/22; B05D 1/12; B05D 7/00

(52) U.S. Cl. 428/339; 428/522; 428/421; 427/186; 427/407.1

(57) ABSTRACT

A protective coating for a roof membrane of the type having plasticizers. The protective or barrier seal coating is applied the exposed surface of the polymeric roofing material, where it prevents and/or retards plasticizer migration to the surface of the membrane where they are subsequently removed. By preventing or retarding loss of plasticizers from the roof membrane, the concentration gradient of plasticizers throughout the membrane can be maintained and the life of the membrane can be extended. The protective or barrier seal coating may be further coated with conventional coatings such as elastomeric acrylics. Methods of applying the protective or barrier seal coating are disclosed.

### FIELD OF THE INVENTION

The present invention relates to roofing membranes. More particularly, the present invention relates to methods and materials used to extend the life of a polymeric roofing membrane.

### BACKGROUND OF THE INVENTION

Flexible sheet membranes (sometimes referred to as “single ply roofing”) have become the predominant method for weatherizing low slope roofs of commercial, industrial, and institutional buildings.

The benefits of using flexible sheet membranes as weatherizing material for roofing are numerous. Such membranes are typically manufactured in factories, where a high level of quality control can be instituted and maintained. Customization can be easily achieved and roofs that have irregularly shaped or non-standard surface areas can be readily accommodated. In addition, because fabrication costs and materials are minimized, the subsequent cost of installation is reduced.

Other benefits are derived from the material itself. The inherent pliability of the flexible membrane allows it to accommodate non-planar surfaces that may be convex or concave, or which may include angular ridges or channels. Such pliability also allows the membrane to maintain its structural integrity as the underlying building roof undergoes thermal expansion and contraction cycles. By choosing appropriate coloration, flexible membranes can also reduce the heating and cooling loads of a building. Moreover, they may be used in aesthetically pleasing ways, providing designers with nearly limitless options for color, texture and building geometry. In addition, flexible membranes resist mold, bacterial growth, rot, root penetration, and fire. They offer a favorable life-cycle cost and are comparatively easy to repair and maintain.

Of the materials used in polymeric roofing membranes, thermoplastic materials such as polyvinyl chloride (PVC) and blends or mixtures of PVC and thermoplastic polyolefins (TPO), are preferred. These materials have advantages over other materials such as thermoset plastics, in that they can be repeatedly softened and hardened by heating and cooling. Moreover, thermoplastic materials can be thermally or chemically joined together and develop bond strengths that can equal or surpass the strength of the base material.

As will be understood, polyvinyl chloride (PVC), by itself, is generally not suitable for use as a roofing membrane because it is too rigid. However, it can be easily modified by adding plasticizers during the manufacturing process. Plasticizers impart flexibility to the PVC because they enable the long polyvinyl molecules of the base material to slide against one another. Typical plasticizers include phthalates, adipates and trimellitates.

A drawback with many existing PVC roofing membranes is that plasticizers tend to migrate out of the body of the membrane. Plasticizer migration most commonly occurs from exposure to elevated temperatures, ultraviolet (UV) radiation, and to a lesser extent through mechanical processes such as erosion and abrasion. Over time, plasticizers, which are more volatile than the membrane, tend to migrate to the surface of the membrane where the volatile components evaporate into the atmosphere and where the non-volatile components remain. The non-volatile components of the plasticizers can be troublesome because of their generally tacky nature, which can easily capture and retain particulates and other matter that lands thereon. This has the effect of reducing the reflectivity of the membrane and increases the heating and cooling loads of the building.

As will be appreciated, when plasticizers migrate out of a membrane, the body of the membrane can, over time, become measurably thinner. It is not unusual for a membrane to lose 10% of its thickness due to plasticizer migration over the course of four or five years. As a result, the membrane becomes less pliable and increasingly rigid and brittle. Cracks can develop and propagate as a result of impacts from objects such as hailstones. Cracks can also develop and propagate due to the membrane's inability to accommodate differences in coefficients of thermal expansion and contraction between the membrane and the substructure to which it is attached. When such cracks develop, they indicate that the roof membrane has exceeded its useful life and must be replaced.

To lessen the effect of embrittlement, it is known to provide the PVC membrane with a protective top coat. While the provision of a top coat does increase the impact resistance of the membrane, it does not address the problem of plasticizer migration. In fact over time, it is a fairly common occurrence for plasticizers to migrate not only from the PVC membrane, but through the top coat as well. This leads to the same problem that occurs when the non-volatile components of plasticizers accumulate on the surface of a non-coated PVC membrane. That is, a reduction in reflectivity, which leads to increased heating and cooling loads.

There is a need to overcome some of the problems and shortcomings associated with plasticizer migration in a polymeric membrane.

### BRIEF SUMMARY OF THE INVENTION

The present invention is intended to prevent or retard the loss of plasticizers from a polymeric roof membrane. This is achieved, generally, by providing the membrane with a barrier layer that prevents plasticizers from migrating out of the membrane. As will be understood, plasticizer migration may be prevented by several mechanisms. For example, the barrier layer may comprise a passive material that resists movement of plasticizers therethrough. This could take the form of material that is relatively immiscible to plasticizers or material that has a molecular weight that is sufficiently high enough to resist infusion of plasticizers. Alternatively, the barrier layer may comprise an active material that has a plasticizer concentration that is greater than the plasticizer concentration of the membrane. In such a situation, a plasticizer gradient is formed, and plasticizers are encouraged to migrate from the barrier layer towards the membrane. In yet another alternative, the barrier layer may comprise a plurality of layers of passive and active material.

Generally, the present invention comprises a barrier layer comprising a primary solvent, a secondary solvent or cosolvent, and resin. More particularly, the primary and secondary solvents, account for a majority of the composition by volume, while the resin, which is a solvent based acrylic resin accounts for a substantial portion of the remainder of the composition, by volume.

An object of the invention is to reduce the migration of plasticizers out of a polymeric membrane.

Another object of the present invention is to increase the working life of a polymeric membrane.

A feature of the present invention is that it may be applied to a membrane prior to or after installation of the membrane onto a structure.

An advantage of the present invention is that it may be easily applied to a polymeric membrane in liquid form.

Another advantage of the present invention is that it permanently bonds with a polymeric membrane and forms a unitary structure.

Yet another advantage of the invention is that it can be used in conjunction with other coatings having other desirable or complimentary attributes.

Yet another advantage of the present invention is that it can extend, by a factor of 2 to 4, the usable life of a polymer membrane.

Additional objects, advantages and features of the invention will be set forth in part in the description which follows, and in part will become apparent to those skilled in the art upon examination of the following or may be learned by practice of the invention. The objects and advantages of the invention may be realized and attained by means of the instrumentalities and combination particularly pointed out in the appended claims.

### BRIEF DESCRIPTION OF THE DRAWINGS

FIG. 1 is a cross-sectional, side elevational view of a prior art roofing membrane;

FIG. 2 is a cross-sectional, side elevational view of the prior art roofing membrane of FIG. 1 with a top coat applied thereto; and,

FIG. 3 is a cross-sectional, side elevational view of an embodiment of the present invention.

### DESCRIPTION OF THE PREFERRED EMBODIMENT

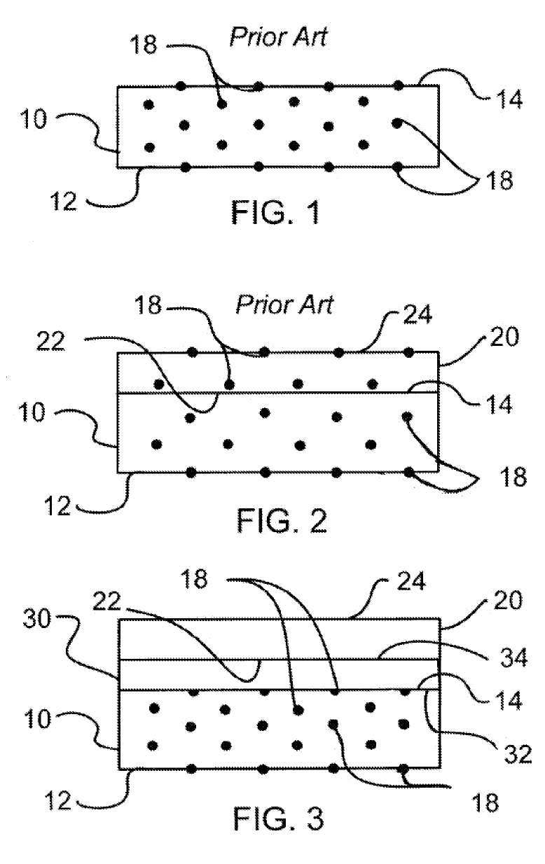

A cross-sectional view of a prior art polymeric membrane is shown in FIG. 1. plasticizers 16, which initially are distributed equally throughout the membrane matrix, including the exposed surfaces. As depicted, the non-volatile components of the plasticizers 16, which have been driven to the surface of the membrane, are generally tacky and tend to remain on the second surface 14 where they can capture and retain particulates and other matter that happens to impinge thereon. This reduces the reflectivity of the membrane, which increases the heating and cooling loads. In addition, the exposed plasticizers change the appearance of the membrane, to its detriment. Over time, the plasticizers that reside on the exposed surfaces will usually be removed due to exposure to the elements, notably water. However, as the surface plasticizer is removed the equilibrium of the plasticizers is disturbed and the remaining plasticizers form a concentration gradient. As will be understood, the tendency of the remaining plasticizers is to reestablish a state of equilibrium throughout the membrane. In doing so, more plasticizers are driven to the second surface 14 where they are eventually removed. Over time, the thickness and the flexibility of the membrane will decrease. This leaves the membrane more susceptible to damage from impacts and thermal stress. As will be understood, once the membrane has been damaged, as by hailstones, for example, cracks can develop and propagate. When this occurs, the ability of the membrane to protect the structure that it covers from the elements, particularly moisture, will be compromised.

In an effort to protect membranes from impacts, it is often the practice to provide membranes with protective coatings. As shown in FIG. 2, the second surface 14 of the membrane 10 has been provided with such a protective coating 20. While the protective coating may comprise a variety of materials (such as bitumen, gravel and felt), polyurethanes, silicones, liquid rubber, or acrylics are preferred. And, within the set of preferred acrylic coatings, elastomeric acrylics, such as Eraguard 1000™, manufactured by E.R. Systems, Inc. of Rockford, Minn., and the like are preferred. The elastomeric acrylic coating 20, as shown, has a first surface 22 and a second surface 24 and is usually applied to the membrane after it has been installed on a roof. However, it will be understood that the coating 20 may be applied to the membrane 10 at the time of manufacture. The coating 20 may be applied in liquid form to a thickness on the order of 10-30 mils (wet). Alternatively, the coating 20 may be formed as a sheet and then applied to the membrane to form a laminated structure. The primary reason for providing a membrane 10 with such a coating 20 is to increase the membrane's resistance to fracture from impacts. An ancillary benefit of applying the coating is that plasticizer migration may be delayed. However, over time, not only can plasticizers 16 migrate through the membrane 10, they can also migrate through the elastomeric coating 20 as well—often at a rate greater than or equal to the rate of migration through the membrane 10. Again, this leaves the membrane and its elastomeric acrylic coating open to damage from impacts and thermal stress. And, once the membrane and its coating have been damaged, cracks can develop and propagate and the membrane will lose its ability to protect the structure that it covers.

The present invention is intended to prevent the loss of plasticizers from a polymeric roofing membrane. As depicted in FIG. 3, this is accomplished by applying a barrier layer 30 to the surface 14 of the roofing membrane 10; the barrier layer 30 having properties that prevent the movement or migration of plasticizers therethrough. Note that the plasticizers 18 are depicted as being evenly dispersed throughout the membrane 10 and that they do not extend into the barrier layer 30 or the superposed elastomeric coating 20 to any appreciable extent. While the barrier layer may generally comprise a variety of passive materials, such as solvent based acrylics and fluoropolymers, or high-molecular weight material, the barrier layer may also comprise active material that has a higher concentration of plasticizers than the membrane to which it is applied. Of the two functionally different types of barrier layers that can prevent or retard the loss of plasticizers from a polymeric membrane, the passive material that has a single high molecular weight is preferred. Generally, such a barrier layer material has a molecular weight of around 10,000 atomic mass units (daltons) and comprises a solvent, a cosolvent, and resin, where the solvent and cosolvent comprise a majority of the composition, by volume. More specifically, the solvent comprises butyl acetate and the cosolvent comprises a bio-based cosolvent, with the butyl acetate having a range of about 45 to 65 percent by volume and the bio-based cosolvent having a range of about 10 to 15 percent by volume. The resin, which comprises about 20 to 30 percent of the barrier layer composition by volume, comprises an acrylic resin and a fluoropolymer, with the acrylic resin having a range of about 85 to 99 percent by volume, and the fluoropolymer having a range of about 1 to 15 percent by volume. The barrier layer composition may also comprise a pigment and/or filler having a range of about 1 to 10 percent by total volume. More preferably, the barrier layer comprises a material such as ER Barrier Coat™, manufactured by E.R. Systems, Inc. of Rockford, Minn., or the like. While the butyl acetate, bio-based cosolvent, and acrylic resin form the basis of a preferred embodiment of the barrier layer composition, it is understood that other solvents, cosolvents, and resins having the same or similar properties may be used without departing from the spirit and scope of the invention.

Of the material that has a higher concentration of plasticizers than the base material to which it is applied, preplasticized acrylics are preferred. It will be appreciated such material creates a negative plasticizer gradient that prevents migration of plasticizers out of the membrane. Moreover, there is a tendency for the plasticizers of the barrier layer to migrate into the membrane.

As will be understood, the barrier layer may also comprise a plurality of layers of the above described material. For example, passive and active material having high molecular weights and high concentrations of plasticizers, respectively, that may be formed into a laminated structure. Moreover, each of the aforementioned barrier layers may be applied prior to or after a roofing membrane has been installed onto a structure.

A preferred method for preventing plasticizers from migrating to a surface of a previously installed polymeric roofing membrane is as follows. The polymeric roofing membrane is first cleaned of extraneous material. Preferably this is achieved using material that will not leave any residue, such as water. The membrane is then allowed to dry. The barrier layer, or first coating, is applied to the membrane, preferably in liquid form to a thickness of about 1 to 15 wet mils, and more preferably about 4 to 10 wet mils. It will be understood that the liquid barrier layer may be applied by using conventional techniques and technologies such as a brush or a roller, or it may be aerosolized (with or without an electric charge) and sprayed using a propellant such as a pressurized gas. It will also be understood that the preferred thickness of the barrier layer may comprise one or more applications.

After the barrier layer has dried sufficiently, preferably to a thickness in the range of around 1 to 7 mils, a protective layer or second coating may be applied, also preferably in liquid form. As with the barrier layer, the second coating may be mechanically or non-mechanically applied; preferably to a thickness of about 10-30 wet mils.

Another preferred method for preventing plasticizers from migrating to a surface of a polymeric roofing membrane is to treat the membrane before it is installed onto a structure. Generally, this may take place at any time prior to installation onto a structure, however, it will be understood that optimum results will be achieved at the site where the roofing membrane is manufactured. For example, in a factory setting where environmental conditions are closely controlled, the step of cleaning the surface to be coated may be omitted. Whereas if a roofing membrane is brought to a building site and then coated prior to installation onto a structure, it may be desirable to clean the surface of extraneous debris. In either case, the barrier layer or first coating may be applied to the surface of the membrane in liquid form as previously discussed. After the barrier layer has cured, the roofing material may be packaged for shipment. As will be appreciated, curing may be accelerated with an additional step, such as heating.

After the barrier layer has dried sufficiently, a protective layer or second coating may be applied, also preferably in liquid form. As with the barrier layer, the second coating may be mechanically or non-mechanically applied; preferably to a thickness of about 10-30 wet mils. And, as discussed above, the protective layer may be applied at the factory or prior to installation onto a structure.

Alternatively, method for preventing plasticizers from migrating to a surface of a previously installed polymeric roofing membrane is as follows. Here, the barrier layer or first coating may be applied to the membrane in sheet form, with the barrier layer having a thickness of about 1 to 7 mils, and preferably about 2 to 5 mils. The barrier layer may be attached to the membrane by applying a sufficient amount of heat energy, or by the use of a suitable adhesive. After the barrier layer has been applied to the roofing membrane, a protective layer or second coating may be applied. As with the previously described embodiments, the protective coating may also take the form of sheeting, in which case it will have a total thickness in the range of about 1-9 mils. It will be noted, though, that the protective coating may be in liquid form, in which case it will have a total thickness in the range of about 10-30 mils.

As with one of the previously described embodiments, the above method may be modified for use on a roofing membrane prior to installation onto a structure. With such a method, the barrier layer (in sheet form) may be bonded to the roofing membrane in the factory using conventional techniques such as calendering. Alternatively, the barrier layer may be attached to the roofing membrane by use of a suitable adhesive or by the application of an effective amount of heat. After the barrier layer or first coating has been attached to the roofing membrane, the membrane may be packaged for shipping. However, it will be understood that a protective coating may be applied prior to packaging if desired. Again, as described above, the protective coating may also take the form of sheeting or may take the form of liquid, which is applied by using conventional applicators or sprayers.

In yet another alternative, it is envisioned that the barrier layer itself may comprise an adhesive having a high molecular weight, having plasticizers that are greater than the concentration of plasticizers in the roofing membrane, or a combination of high molecular weight and high concentration of plasticizers. With this embodiment, the method of preventing plasticizers from migrating to a surface of a previously installed polymeric roofing membrane is as follows. After the barrier layer or first coating is applied to the roofing membrane, and before it has cured, a protective layer or second coating in sheet form may be applied thereto. As will be appreciated, the protective coating would not, in this embodiment, be limited to a particular material, and could encompass other materials having properties similar to acrylic elastomers. For example, PVC membranes, polyurethane membranes or TPO membranes.

What is claimed is:

1. A polymeric roofing material, the polymeric roofing material comprising a first sheet, the first sheet being a roofing membrane containing plasticizers, the membrane having a first surface, the plasticizers having a tendency to migrate to the first surface; the polymeric roofing material further comprising first and second coatings, the first coating located between the first surface of the first sheet and the second coating, the first coating providing a barrier to migration of the plasticizers from the roofing membrane to the second coating, the second coating being primarily an elastomeric acrylic.

2. The polymeric roofing material of claim 1, wherein the first coating substantially covers the roofing membrane, and wherein the first coating has a thickness in the range of about 1 to 7 mils.

3. The polymeric roofing material of claim 1, wherein the first coating has a thickness less than 7 mils.

4. The polymeric roofing material of claim 1, wherein the first coating has a thickness greater than 1 mil.

5. The polymeric roofing material of claim 1, wherein the polymeric roofing material comprises polyvinyl chloride.

6. The polymeric roofing material of claim 1, wherein the first coating comprises an acrylic resin.

7. The polymeric roofing material of claim 6, wherein the first coating further comprises a fluoropolymer.

8. The polymeric roofing material of claim 6, wherein the first coating further comprises a solvent.

9. A polymeric roofing material, the polymeric roofing material comprising a first sheet, the first sheet being a roofing membrane containing plasticizers, the membrane having a first surface, the plasticizers having a tendency to migrate to the first surface of the membrane; the polymeric roofing material further comprising a first coating, the first coating providing a barrier to migration of the plasticizers to the first surface of the membrane.

10. The polymeric roofing material of claim 9, wherein the first coating substantially covers the roofing membrane, and wherein the first coating has a thickness in the range of about 1 to 7 mils.

11. The polymeric roofing material of claim 9, wherein the first coating has a thickness less than 7 mils.

12. The polymeric roofing material of claim 9, wherein the first coating has a thickness greater than 1 mil.

13. The polymeric roofing material of claim 9, further comprising a second layer, the second layer comprising an acrylic elastomeric material.

14. The polymeric roofing material of claim 9, wherein the polymeric roofing material comprises polyvinyl chloride.

15. A polymeric roofing material of either claim 1 or 9, wherein the first coating is made of a polymeric material selected from the group consisting of: a material having a molecular weight of greater than about 10,000 atomic mass units (daltons), and a material having a concentration of plasticizers greater than the concentration of plasticizers in the roofing membrane.

16. A method of preventing plasticizers from migrating to a surface of a polymeric roofing membrane, the method comprising the step of coating the surface of the membrane with a layer of material that comprises acrylic resin.

17. The method of preventing plasticizers from migrating to a surface of a polymeric roofing membrane of claim 16, wherein the step of coating the surface of the membrane comprises applying the acrylic resin in liquid form.

18. The method of preventing plasticizers from migrating to a surface of a polymeric roofing membrane of claim 16, further comprising the step of drying the acrylic resin.

19. The method of preventing plasticizers from migrating to a surface of a polymeric roofing membrane of claim 17, further comprising the step of coating the acrylic resin with a coating comprising elastomeric acrylic.

20. The method of preventing plasticizers from migrating to a surface of a polymeric roofing membrane of 16, wherein the step of coating the surface of the membrane comprising the step of applying the acrylic resin in solid form.

21. The method of preventing plasticizers from migrating to a surface of a polymeric roofing membrane of claim 16, wherein the step of applying the acrylic resin comprises calendering.

22. A method of preventing plasticizers from migrating to a surface of a polymeric roofing membrane, the method comprising the step of coating the surface of the membrane with a layer of acrylic resin to a thickness of about 1 to 7 mils.

23. The method of preventing plasticizers from migrating to a surface of a polymeric roofing membrane of claim 22, wherein the step of coating the surface of the membrane with a layer of acrylic resin to a thickness of about 2 to 4 mils.

24. A method of preventing plasticizers from migrating to a surface of a pre-installed polymeric roofing membrane, the method comprising the steps of:
a) preparing the surface of the pre-installed polymeric roofing membrane, and,
b) the step of coating the surface of the membrane with a layer of acrylic resin to a thickness of about 1 to 7 mils.
